(19) United States
(12) Patent Application Publication
(10) Pub. No.: US 2018/0193817 A1
(43) Pub. Date: Jul. 12, 2018

(54) CONTINUOUSLY RUNNING EXOTHERMIC REACTOR SYSTEM

(71) Applicant: IHL Holdings Limited, Raleigh, NC (US)

(72) Inventor: Kyu-Jung Kim, Mahomeet, IL (US)

(21) Appl. No.: 15/617,364

(22) Filed: Jun. 8, 2017

Related U.S. Application Data
(60) Provisional application No. 62/347,910, filed on Jun. 9, 2016.

(51) Int. Cl. B01J 19/18; B01J 19/24; B01J 8/06

(52) U.S. Cl. CPC B01J 19/1856; B01J 19/2475; B01J 8/062; F24J 1/00; B01J 2219/00065; B01J 2219/00087; B01J 2219/00164; B01J 2219/00063

(57) ABSTRACT

A heat generating system comprises two or more thermal reactors. During operation, a first thermal reactor is pressurized while a second thermal reactor is depressurized to vent unused gas and byproduct. The unused gas and byproduct from the second reactor are separated in a gas separator and the unused gas is supplied to the first reactor while the first reactor is pressurized. An exothermic reaction is triggered in the first reactor, which results in generation of heat and byproduct cluster formation. When the exothermic reaction is complete, the process is reversed and the second thermal reactor is pressurized while the first reactor is depressurized.

### CROSS-REFERENCE TO RELATED APPLICATION

This application claims the benefit of priority of U.S. Provisional Patent Application No. 62/347,910, titled “A CONTINUOUSLY RUNNING EXOTHERMIC REACTOR SYSTEM” filed on Jun. 9, 2016 which is incorporated herein in its entirety by this reference.

### TECHNICAL FIELD

The present disclosure relates generally to alternative energy technologies and, more particularly, to thermal reaction systems.

### BACKGROUND

Over the past 30 years, scientists have observed the phenomena of excess heat being generated when a transition metal or metal alloy such as palladium, nickel or platinum, is exposed to hydrogen gas, or one of its isotopes under pressure.

U.S. Pat. No. 8,603,405 (hereinafter the '405 patent) discloses a thermal reactor based on dislocation site techniques. The reactor is designed to generate an exothermic reaction based on the interaction between one or more isotopes of hydrogen and a plurality of metallic micro-structures. A plurality of metallic micro-structures is exposed to gas comprising hydrogen or an isotope of hydrogen under pressure inside a reaction chamber. The process gas, comprising hydrogen or an isotope thereof, is applied via a gas inlet to the reaction chamber containing the metallic micro-structures. The reaction chamber is pressurized to form hydrogen clusters in the interstitial spaces of the metallic micro-structures. When the pressure inside the reaction chamber reaches a pre-determined level, an exothermic reaction is triggered. The exothermic reaction continues until the hydrogen clusters are consumed by the reaction. During the reaction, anomalous heat is generated. Once the hydrogen clusters are used, a vent is opened and the reactor is depressurized to remove the reaction byproducts.

While the reaction system described in the '405 patent is useful for generating excess heat, there are some drawbacks to the reaction system. One drawback is that the heat generating process is periodic or cyclical. The reactor must be periodically pressurized to trigger the reaction and then depressurized to remove byproduct. While the byproduct is being removed, the reactor is not producing heat so the heat output of the reactor system fluctuates over time. Another drawback is that the depressurization of the reactor removes not only the reaction byproduct, but also unused gas that, for whatever reason, is not consumed or converted in the reaction. The venting of the unused gas results in lower thermodynamic efficiency and hence greater operating costs.

### SUMMARY

The present disclosure relates generally to a heat generating system and a method of operating the same. The system comprises two or more thermal reactors. During operation, a first thermal reactor is pressurized while a second thermal reactor is depressurized to vent unused gas and byproduct. The unused gas and byproduct from the second reactor are separated in a gas separator and the unused gas is supplied to the first thermal reactor while the first thermal reactor is pressurized. In one embodiment, pressurization of the first reactor triggers an exothermic reaction in the first thermal reactor, which results in generation of heat and byproduct cluster formation. When the exothermic reaction in the first thermal reactor is complete, the process is reversed. The second thermal reactor is pressurized while the first reactor is depressurized. Alternating the pressurization and depressurization of two or more thermal reactors in this manner results in a more uniform heat generation over time. Further, this system recaptures and recycles unused gas resulting in greater thermodynamic efficiency.

An exemplary embodiment of the disclosure comprises a thermal reaction system for generating heat. In one embodiment, the thermal reaction system comprises first and second thermal reactors. A compressor is configured to supply, during a first time period, gas to the first thermal reactor to pressurize the first thermal reactor while simultaneously venting unused gas and byproduct from the second thermal reactor to depressurize the second thermal reactor. A gas separator is configured to separate, during the first time period, the unused gas and byproduct vented from the second thermal reactor. A return line connects an output of the gas separator to an inlet of the compressor to recycle, during the first time period, the unused gas vented from the second thermal reactor to the first thermal reactor.

In another embodiment, the compressor is further configured to supply, during a second time period, gas under pressure to the second thermal reactor to pressurize the second thermal reactor while simultaneously venting unused gas and byproduct from the first thermal reactor to depressurize the first thermal reactor. The gas separator is further configured to separate, during the second time period, the unused gas and byproduct vented from the first thermal reactor. The return line recycles, during the second time period, the unused gas vented from the first thermal reactor to the second thermal reactor.

Other embodiments comprise a heat generation method. In one embodiment of the method, gas under pressure is supplied, during a first time period, to a first thermal reactor to pressurize the first thermal reactor while simultaneously venting unused gas and byproduct from the second thermal reactor to depressurize the second thermal reactor. During the first time period, the unused gas and byproduct vented from the second thermal reactor is separated and the unused gas is recycled to the first thermal reactor.

In another embodiment, during a second time period, gas under pressure is supplied to the second thermal reactor to pressurize the second thermal reactor while simultaneously venting unused gas and byproduct from the first thermal reactor to depressurize the first thermal reactor. The unused gas and byproduct vented from the first thermal reactor during the second time period is separated in a gas separator and the unused gas is recycled to the first thermal reactor.

### BRIEF DESCRIPTION OF THE DRAWINGS

FIG. 1 illustrates an exemplary reactor system including two sets of thermal reactors.

FIG. 2A illustrates the reactor system of FIG. 1 in a first operating mode where a first set of reactors is being pressurized and a second set of reactors is being depressurized.

FIG. 2B illustrates the reactor system of FIG. 1 in a second operating mode where a first set of reactors is being depressurized and a second set of reactors is being pressurized.

FIG. 3 illustrates a heat exchange unit for an HVAC system incorporating the thermal reactors.

FIG. 4 illustrates an exemplary reactor system including three sets of thermal rectors.

FIG. 5A illustrates the reactor system of FIG. 4 in a first operating mode where a first set of reactors and a second set of reactors are being pressurized while a third set of reactors is being depressurized.

FIG. 5B illustrates the reactor system of FIG. 4 in a second operating mode where the first set of reactors and third set of reactors are being pressurized while the second set of reactors is being depressurized.

FIG. 5C illustrates the reactor system of FIG. 4 in a third operating mode where the second set of reactors and third set of reactors are being pressurized while the first set of reactors is being depressurized.

FIG. 6 illustrates an exemplary method of operating the thermal reactor system.

FIG. 7 illustrates a control circuit for controlling the thermal reactor system.

### DETAILED DESCRIPTION

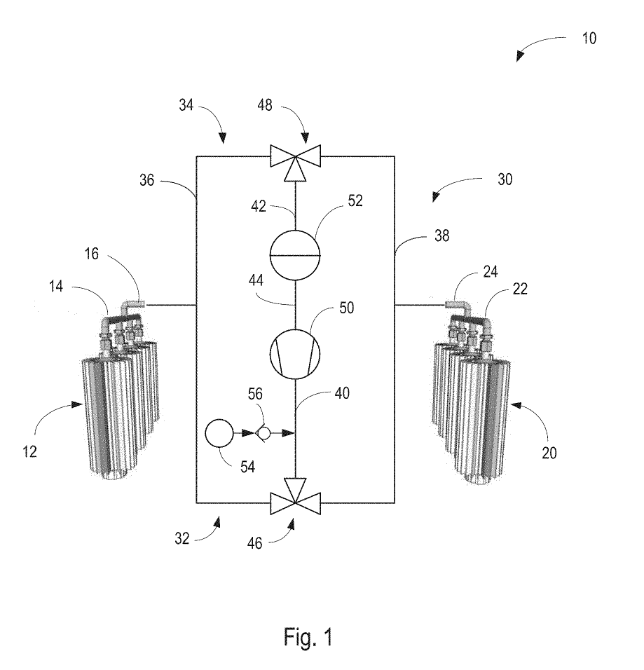

In referring now to the drawings, FIG. 1 illustrates a first exemplary embodiment of a thermal reaction system, which is indicated generally by the numeral 10. The main functional components of the thermal reaction system 10 comprise a first set of thermal reactors 12, a second set of thermal reactors 20, and a flow control system 30 for directing gas from a gas source 54 to the first and second sets of reactors 12 and 20. The gas source 54 connects to the flow control system 30 via a check valve 56. The first set of reactors 12 connects to the flow control system 30 via a manifold 14 and input/output (I/O) port 16. The second set of reactors 20 connects to the flow control system 30 via a manifold 22 and a second I/O port 24 to the flow control system 30.

As will be hereinafter described in greater detail, the operating cycles of the first set of reactors 12 is staggered with respect to the operating cycles of the second set of reactors 20 so that, while one set of reactors 14, 20 is pressurized, the other set of reactors 20, 14 is depressurized. For example, during the first time period, the flow control system 30 supplies hydrogen gas or other process gas to the first set of reactors 12 while simultaneously depressurizing the second set of reactors 20. As used herein, the term hydrogen gas includes any gaseous isotope of hydrogen including deuterium and tritium. During the second time period, the flow control system 30 supplies gas under pressure to the second set of reactors 20 while simultaneously depressurizing the first set of reactors 12. During normal operation, the first and second sets of reactors 12, 20 are alternately pressurized and depressurized in this fashion to provide a more uniform heat output over time.

The flow control system 30 comprises a compressor 50, gas separator 52, gas supply line 32, exhaust line 34, and branch lines 36 and 38 connected in parallel between the gas supply line 32 and exhaust line 34. Branch line 36 is in fluid communication with the I/O port 16 for the first set of reactors 12. Branch line 38 is in fluid communication with the I/O port 24 for the second set of reactors 20.

The gas supply line 32 is connected via a three-way control valve 46 to a compressor 50. The three-way control valve 46 includes an input port and two output ports. Input port is connected via line 40 to an output of the compressor 50. The output ports communicate with the gas supply line 32. The first output port connects to a first segment of the gas supply line 32 in fluid communication with branch line 36. A second output port connects to a second segment of the gas supply line 32 in fluid communication with branch line 38.

Similarly, the exhaust line 34 includes a three-way control valve 48 that connects the exhaust line 34 to the gas separator 52. The three-way control valve 48 includes an output port and two input ports. The output port is connected via line 42 to an intake of the gas separator 52. The two input ports connect to the exhaust line 34. A first input port connects to a segment of the exhaust line 34 in fluid communication with branch line 38. The second input port connects to a segment of the exhaust line 34 in fluid communication with branch line 36.

The output of the gas separator 52 is connected via line 44 to the intake of the compressor 50. As will be hereinafter described in detail, unused gas and byproduct vented from reactors 12 and 20 are separated by the gas separator 52. The byproduct is vented from the system and the unused gas is recycled via line 44 to the gas compressor 50.

The gas separator 52 includes an inlet and an outlet. The inlet 52 of the gas separator is connected via line 42 to the output port of three-way valve 48. The output of the gas separator 52 is connected via line 44 to the intake of the compressor 50. In one embodiment, the gas separator 52 includes a membrane for separating unused gas and byproduct. The unused gas is allowed to pass via line 44 to the compressor 50 to be recycled.

The gas source 54 connects via a check valve 56 to the line 40 connecting the output of the compressor to the input port of valve 46. The gas source 54 supplies fresh gas to the flow control system 30 to account for the loss of gas that is removed as byproduct in the separator 162.

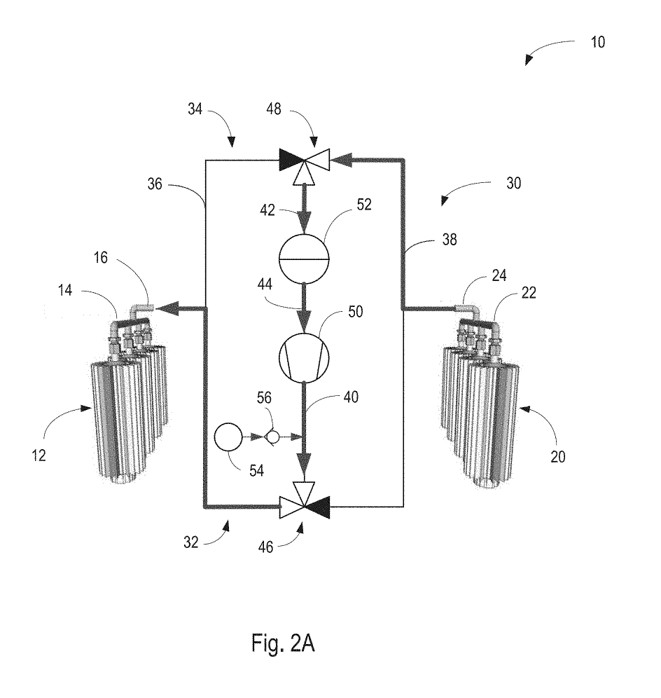

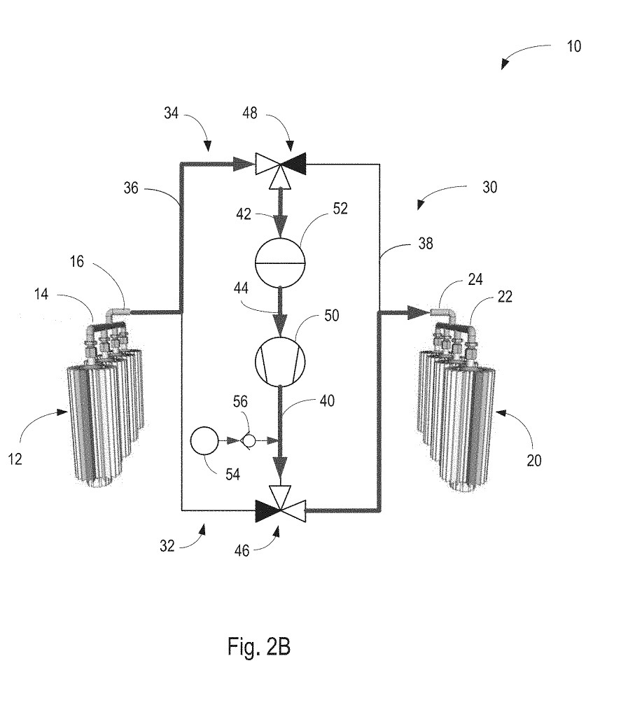

FIGS. 2A and 2B illustrate the operation of the thermal reaction system 10 during first and second time periods respectively. As shown in FIG. 2A, the second output port of three-way control valve 46 and first input port of three-way valve 48 are closed. The closed ports are indicated by a solid black fill. In this configuration, the compressor 50 supplies gas under pressure to the first set of reactors 12 via branch line 36. While the first set of reactors 12 is being pressurized, the second set of reactors 20 is depressurized via branch line 38. Unused gas and byproduct flows through branch line 38 and three-way valve 48 to the intake of the gas separator 52. The unused gas and byproduct from the second set of reactors 20 are separated and the unused gas flows through line 44 to the intake of compressor 50. Thus, the unused gas from the second set of reactors 20 is recycled for use by the first set of reactors 12. Additional gas needed to maintain proper pressurization levels is supplied by the gas source 54 via check valve 56 to line 40.

FIG. 2B illustrates the thermal reaction system 10 during a second time period when the second set of reactors 20 is pressurized while the first set of reactors 12 is depressurized. During the second time period, the second output port of the three-way valve 46 and the first input port of the three-way valve 48 are closed. In this configuration, gas is supplied under pressure to the second set of reactors 20 via branch line 38 while unused gas and byproduct are vented from the first set of reactors 12 via branch line 36. The unused gas and byproduct from the first set of reactors 12 is directed by the three-way valve 48 to the intake of the gas separator 52. The unused gas and byproduct from the first set of reactors 12 is separated by the gas separator 52 and the unused gas flows through line 44 to the intake of the compressor 50. Thus, the unused gas from the first set of reactors 12 is recycled for use by the second set of reactors 20. Additional gas needed to maintain proper pressurization levels is supplied by the gas source 54 via check valve 56 to line 40.

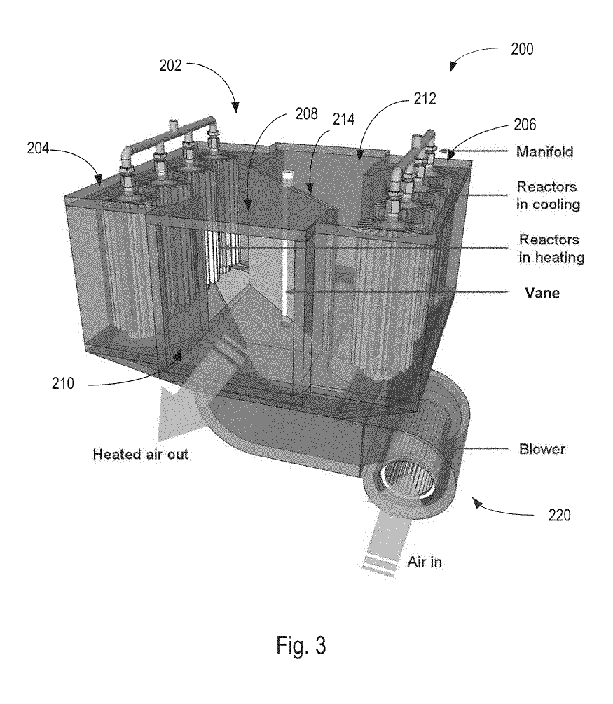

The first and second sets of reactors 12, 20 may be incorporated into a heat exchanger 200 to heat water or air flowing around the reactors 12, 20. FIG. 3 illustrates a heat exchanger 200 used for space heating applications. The heat exchanger 200 includes a housing 202 including a first chamber 204 containing the first set of reactors 12, and a second chamber 206 containing the second set of reactors 20. A blower 220 circulates air through the first and second chambers 204 and 206. Each of the first and second chambers 204 and 206 connects to a central chamber 208 having first and second outlets 210 and 212. A vane 214 controls the flow of air through the heat exchanger 200. The vane 214 is disposed in the central chamber 208 and is rotatable between first and second operational positions. The vane 214 is rotated by a step-motor or similar solenoid actuator. The position of the vane 214 is coordinated with the operating cycles of the first and second sets of reactors 12, 20. When the first set of reactors 12 is being pressurized, the vane 214 is positioned to direct heated air from the first chamber 204 to a first outlet 210 while directing air from the second chamber 206 to a second outlet 212. During the time period when the second set of reactors 20 is being pressurized, the vane 214 is repositioned to direct the air heated by the second set of reactors 20 through the first outlet 210 while directing air from the first chamber 204 through the second outlet 212.

Those skilled in the art will appreciate that the thermal reaction system is not limited to only two sets of reactors. It will be recognized that the principles described herein can be easily extended to any number of reactor sets.

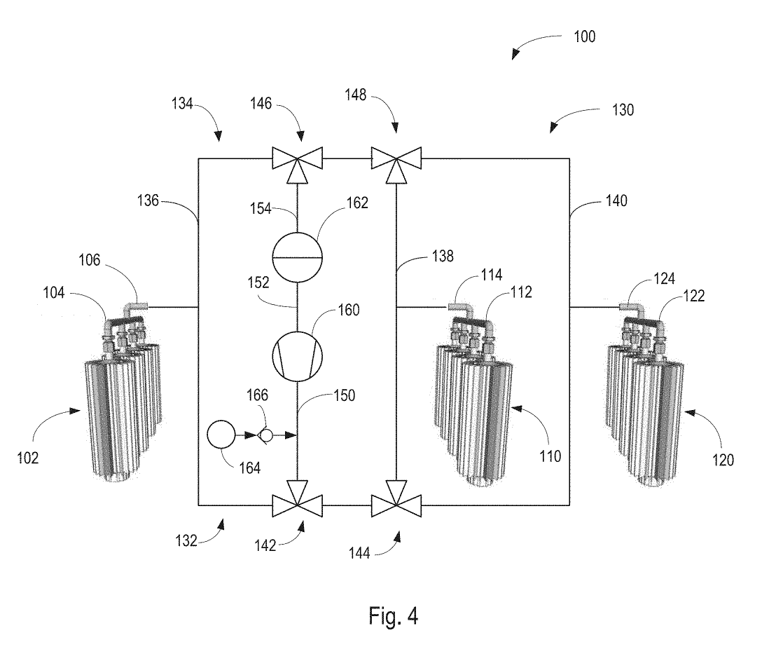

FIG. 4 illustrates a thermal reaction system 100 including three sets of thermal reactors 102, 110, and 120, and a flow control system 130. A gas source 164 connects to the flow control system 130 via a check valve 166. The first set of thermal reactors 102 connects to the flow control system 130 via a manifold 104 and input/output (I/O) port 106. The second set of thermal reactors 110 connects to the flow control system 130 via manifold 112 and second I/O port 114. The third set of thermal reactors 120 connects to the flow control system 130 via a manifold 122 and second I/O port 124.

The flow control system 130 comprises a compressor 160, gas separator 162, a gas supply line 132, an exhaust line 134, and three branch lines 136, 138, and 140 connected in parallel between the gas supply line 132 and exhaust line 134. The gas supply line 132 includes a pair of three-way control valves 142 and 144. Control valve 142 includes one input port and two outlet ports. The input port of control valve 142 is connected via line 150 to the output of the compressor 160. One output port is connected to a segment of the gas line 132 in fluid communication with branch line 136. The other output port connects to a segment of the gas supply 132 between three-way control valve 142 and three-way control valve 144. Three-way control valve 144 includes an input port and two output ports. The input port is connected to the segment of the gas supply line 132 between three-way control valve 142 and three-way control valve 144. One output port is connected to a segment of the gas supply line 132 in fluid communication with branch line 140. A second output port is in fluid communication with branch line 138.

The exhaust line 134 also includes a pair of three-way control valves 146 and 148. Control valve 146 includes two input ports and an output port. A first input port connects to a segment of the exhaust line 134 in fluid communication with branch line 136. The second input port connects to a segment of the exhaust line 134 between three-way control valve 146 and three-way control valve 148. The output port of three-way control valve 146 connects via line 154 to the intake of the gas separator 162. Similarly, three-way control valve 148 includes two input ports and one output port. One input port connects to branch line 138. The other input port connects to a segment of the exhaust line 134 in fluid communication with branch line 140. The output port of three-way control valve 148 is connected to the segment of the gas supply line 134 between three-way control valve 146 and three-way control valve 148.

The gas separator 162 includes an inlet and an outlet. The inlet 162 of the gas separator is connected via line 154 to the output port of three-way valve 146. The output of the gas separator 162 is connected via line 152 to the intake of the compressor 160. The gas separator 162 includes a membrane for separating unused gas and byproduct. The unused gas is allowed to pass via line 152 to the compressor 160 to recycle the unused gas.

The gas source 164 connects via a check valve 166 to the line 150 connecting the output of the compressor 160 to the input port of valve 142. The gas source 164 supplies fresh gas to the flow control system 130.

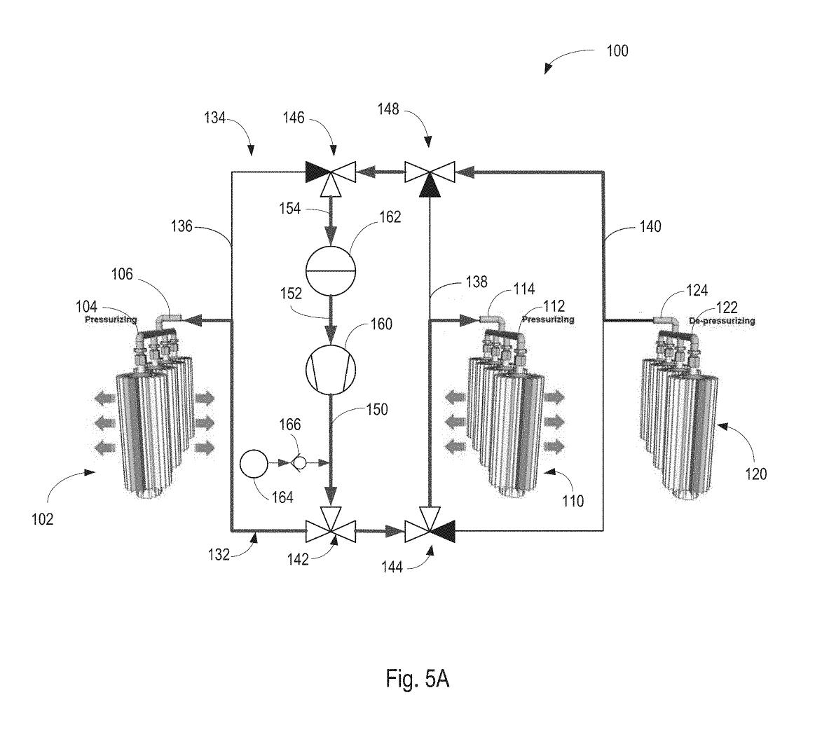

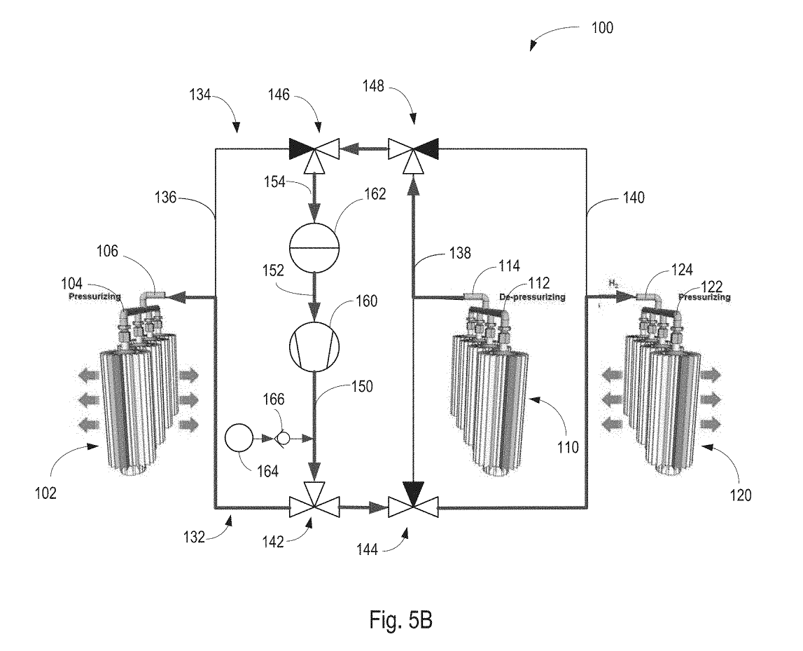

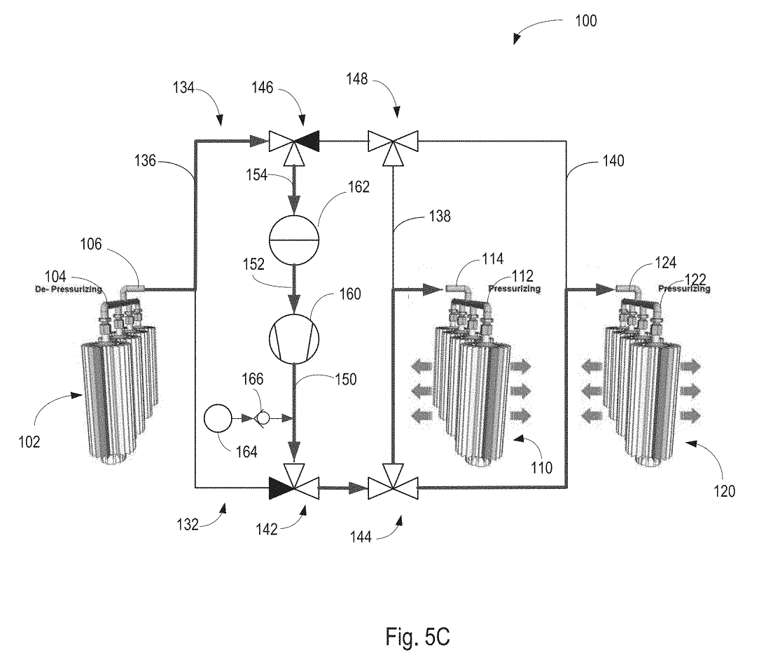

FIGS. 5A-5C illustrate the operation of the thermal reaction system 100 of FIG. 4. During a first time period, illustrated in FIG. 5A, a first output port of three-way valve 144, a first input port of three-way valve 146, and a first input port of three-way valve 148 are closed. In this configuration, the compressor 160 supplies gas under pressure to the first set of thermal reactors 102 and second set of reactors 110 while the third set of thermal reactors 120 is depressurized. The unused gas and byproduct vented from the third set of thermal reactors 120 is directed to the inlet of the gas separator 162 which separates the unused gas and byproduct. The unused gas flows through line 152 to the intake of the compressor 160. Thus, the unused gas from the third set of thermal reactors 120 is recycled for use by the first and second sets of reactors 102, 110.

During a second time period shown in FIG. 5B, a second output port of three-way valve 144, the first input port of three-way valve 146, and a second input port of three-way valve 148 are closed. In this configuration, the compressor 160 supplies gas under pressure to the first set of thermal reactors 102 and the third set of thermal reactors 120 while the second set of thermal reactors 110 is depressurized. Unused gas and byproduct vented from the second set of thermal reactors 110 is directed to the inlet of the gas separator 162 which separates the unused gas and byproduct. The unused gas flows via line 152 to the inlet of the compressor 160. Thus, the unused gas from the second set of thermal reactors 110 is recycled for use by the first and third sets of thermal reactors 102, 120.

During a third time period, shown in FIG. 5C, a first output port of three-way valve 142 and second input port of three-way valve 146 are closed. In this configuration, gas is supplied under pressure to the second set of thermal reactors 110 and third set of thermal reactors 120, while the first set of thermal reactors 102 is depressurized. Unused gas and byproduct from the first set of thermal reactors 102 is directed to the inlet of the gas separator 162 where the unused gas and byproduct are separated. The unused gas flows through line 152 to the inlet of the compressor 160. Thus, the unused gas from the first set of thermal reactors 102 is recycled for use by the second and third sets of thermal reactors 110, 120.

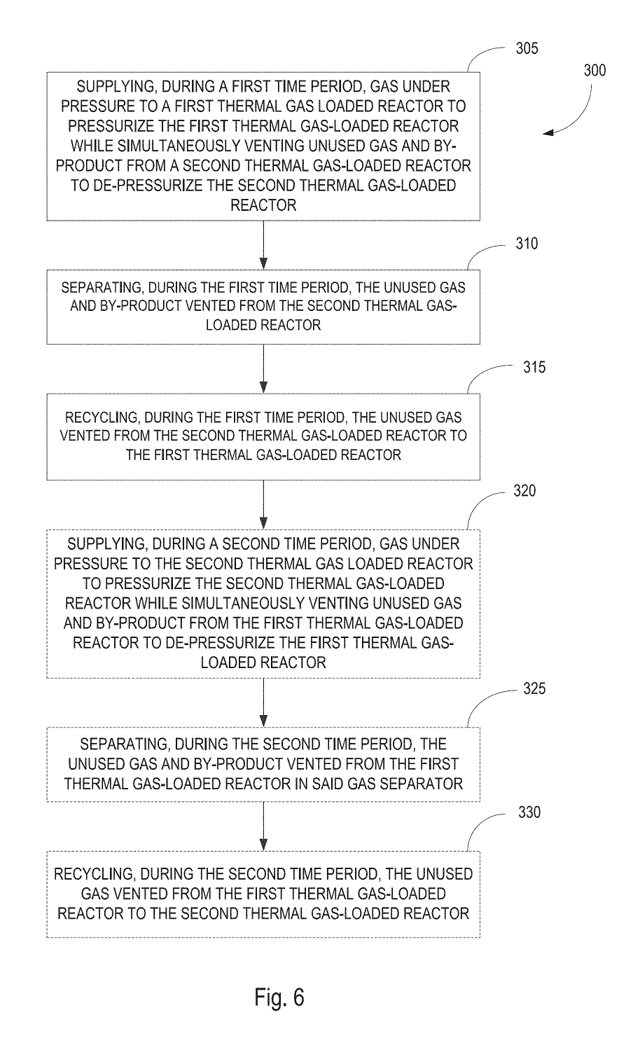

FIG. 6 illustrates a heat generating method 300 using the thermal reaction system 10. Gas under pressure is supplied, during a first time period, to a first thermal reactor to pressurize the first thermal reactor while simultaneously venting unused gas and byproduct from the second thermal reactor to depressurize the second thermal reactor (block 305). During the first time period, the unused gas and byproduct vented from the second thermal reactor is separated (block 310) and the unused gas is recycled to the first thermal reactor (block 315). During a second time period, gas under pressure is supplied to the second thermal reactor to pressurize the second thermal reactor while simultaneously venting unused gas and byproduct from the first thermal reactor to depressurize the first thermal reactor (block 320). The unused gas and byproduct vented from the first thermal reactor during the second time period is separated in a gas separator (block 325) and the unused gas is recycled to the first thermal reactor (block 330).

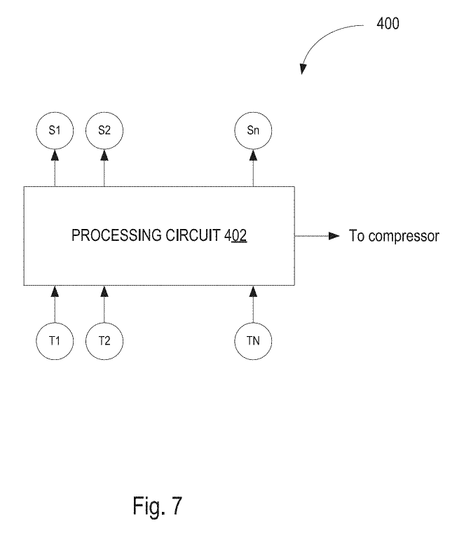

FIG. 7 illustrates an exemplary control circuit 400 for the thermal reaction systems 10 and 100. The control circuit 400 comprises a processing circuit 402 that implements the main control functions of the thermal reaction system 10, 100. The processing circuit 402 is configured to control the thermalreaction system 10, 100 as herein above described. The processing circuit 402 may comprise one or more processors, hardware circuits, firmware, of a combination thereof. The processing circuit 402 receives inputs from temperature sensors T1, T2, . . . , Tn that monitor the heat generation of the thermal gas loaded reactors. Based on the measured temperatures, the processing circuit 402 sends control signals to solenoids or switches S1, S2, . . . , Sn that actuate the control valves, to switch between different operating modes. For example, the processing circuit 402 may use the temperature measurements to determine when the set of reactors currently being pressurized are no longer generating heat and control the valves 46, 48 in the embodiment of FIG. 1, or the valves 142, 144, 146, 148 in the embodiment of FIG. 4 to switch the operating modes. In some embodiments, the processing circuit 402 may also generate and send control signals to a switch or solenoid that controls the compressor.

Based on the foregoing, it is apparent that, by staggering the operative cycles of two or more sets of reactors, the reaction system of the present disclosure is able to continuate heat more uniformly over time. Further, by recycling unused gas, greater thermodynamic efficiency is achieved.

What is claimed is:

1. A thermal reaction system comprising:
a first thermal reactor;
a second thermal reactor;
a compressor configured to supply, during a first time period, gas to the first thermal reactor to pressurize the first thermal reactor while venting unused gas and by-product from the second thermal reactor to de-pressurize the second thermal reactor;
a gas separator configured to separate, during the first time period, the unused gas and by-product vented from the second thermal reactor; and
a return line connecting an output of the gas separator to an inlet of the compressor and configured to recycle, during the first time period, the unused gas vented from the second thermal reactor to the first thermal reactor.

2. The thermal reaction system of claim 1 wherein:
the compressor is further configured to supply, during a second time period, gas under pressure to the second thermal reactor to pressurize the second thermal reactor while simultaneously venting unused gas and by-product from the first thermal reactor to de-pressurize the first thermal reactor;
the gas separator is further configured to separate, during the second time period, the unused gas and by-product vented from the first thermal reactor; and
the return line is further configured to recycle, during the second time period, the unused gas vented from the first thermal reactor to the second thermal reactor.

3. The thermal reaction system of claim 2 further comprising:
one or more gas supply lines connecting on output of the compressor to a first input/output (I/O) port on each of the first and second thermal reactors;
a first control valve operative to direct gas from the compressor to the first thermal reactor during the first time period and from the compressor to the second thermal reactor during the second time period.

4. The thermal reaction system of claim 3 wherein the first control valve comprises:
an input port connected to an output of the compressor;
a first output port connected by a first one of the supply lines to the first I/O port of the first thermal reactor; and
a second output port connected by a second one of the supply lines to the first I/O port of the second thermal reactor.

5. The thermal reaction system of claim 4 further comprising:
one or more suction lines connecting an input of the gas separator to the first I/O port, or to a second I/O port, on each of the first and second thermal reactors; and
a second control valve operative to direct unused gas and byproduct from the second thermal reactor to the input of the gas separator during the first time period and from the first thermal reactor to the input of the gas separator during the second time period.

6. The thermal reaction system of claim 5 wherein the second control valve comprises:
an output port connected to an input of the gas separator;
a first input port connected by a first one of the suction lines to the second I/O port of the second thermal reactor; and
a second input port connected by a second one of the suction lines to the first I/O port of the first thermal reactor.

7. The thermal reaction system of claim 6 further comprising a control circuit for controlling the first and second control valves, the control circuit operable to:
open the first output port of the first control valve and the first input port of the second control valve during the first time period;
close the second output port of the first control valve and the second output port of the second control valve during the first time period;
open the second output port of the first control valve and the second input port of the second control valve during the second time period; and
close the first output port of the first control valve and the first input port of the second control valve during the first time period.

8. The thermal reaction system of claim 4 further comprising a gas source connected between the output of the compressor and the first control valve.

9. The thermal reaction system of claim 1 wherein:
the compressor is further configured to supply, during a second time period, gas under pressure to the second thermal reactor to pressurize the second thermal reactor while simultaneously venting unused gas and by-product from a third thermal reactor to de-pressurize the third thermal reactor;
the gas separator is further configured to separate, during the second time period, the unused gas and by-product vented from the third thermal reactor; and
the return line is further configured to recycle, during the second time period, the unused gas vented from the third thermal reactor to the first thermal reactor.

10. A heat generation method comprising:
supplying, during a first time period, gas under pressure to a first thermal gas loaded reactor to pressurize the first thermal reactor while simultaneously venting unused gas and by-product from a second thermal reactor to de-pressurize the second thermal reactor;
separating, during the first time period, the unused gas and by-product vented from the second thermal reactor; and
recycling, during the first time period, the unused gas vented from the second thermal reactor to the first thermal reactor.

11. The heat generation method of claim 10 further comprising:
supplying, during a second time period, gas under pressure to the second thermal reactor to pressurize the second thermal reactor while simultaneously venting unused gas and by-product from the first thermal reactor to de-pressurize the first thermal reactor;
separating, during the second time period, the unused gas and by-product vented from the first thermal reactor in the gas separator; and
recycling, during the second time period, the unused gas vented from the first thermal reactor to the second thermal reactor.

12. The heat generation method of claim 11 further comprising:
directing, by a first control valve during the first time period, gas from a compressor to the first thermal reactor;
directing, by a first control valve during the second time period, gas from the compressor to the second thermal reactor.

13. The heat generation method of claim 12 further comprising:
supplying, during the first and second time periods, gas from a compressor to an input port of the first control valve;
outputting, by the first control valve during the first time period, the supplied gas to a first output port of the first control valve in fluid communication with the first thermal gas loaded reactor; and
outputting, by the first control valve during the second time period, the supplied gas to a first output port of the control valve in fluid communication with the first thermal gas loaded reactor; and

14. The heat generation method of claim 13 further comprising:
applying, by a second control valve during the first time period, suction to the second thermal reactor;
applying, by the second control valve during the second time period, suction to the first thermal reactor.

15. The heat generation method of claim 14 further comprising:
inputting, during the first time period, unused gas and by-product from the second thermal gas loaded reactor to a first input of the second control valve; and
inputting, during the second time period, unused gas and by-product from the first thermal gas loaded reactor to a second input of the second control valve; and
outputting, during the first and second time periods, unused gas and by-product from one of the first and second thermal reactors from an output of the second control valve to the gas separator.

16. The heat generation method of claim 15 further comprising:
opening, by a control circuit, the first output port of the first control valve and the first input port of the second control valve during the first time period;
closing, by a control circuit, a second output port of the first control valve and a second output port of the second control valve during the first time period;
opening, by a control circuit, the second output port of the first control valve and the second input port of the second control valve during the second time period; and
closing, by a control circuit, the first output port of the first control valve and the first input port of the second control valve during the first time period.

17. The heat generation method of claim 15 further comprising maintaining a predetermined operating pressure by supplying gas from a gas source to the input of the first control valve.

18. The heat generation method of claim 10 further comprising:
supplying, during a second time period, gas under pressure to the second thermal reactor to pressurize the second thermal reactor while simultaneously venting unused gas and by-product from a third thermal reactor to de-pressurize the third thermal reactor;
separating, during the second time period, the unused gas and by-product vented from the third thermal reactor in the gas separator; and
recycling, during the second time period, the unused gas vented from the third thermal reactor to the second thermal reactor.
